(19) United States
(12) Patent Application Publication
(10) Pub. No.: US 2004/0130238 A1
(43) Pub. Date: Jul. 8, 2004

(54) Composite material, for the production thereof and its use

(76) Inventors: Anton Dukart, Gelingen (DE); Franz Jost, Stuttgart (DE)

Correspondence Address: KENYON & KENYON, ONE BROADWAY, NEW YORK, NY, 10004, US

(21) Appl. No.: 10/474,527

(22) PCT Filed: Mar. 19, 2002
(86) PCT No.: PCT/DE02/00981

(30) Foreign Application Priority Data
Apr. 27, 2001 (DE) 101 20 865.0

(51) Int. Cl. H02N 2/00

(52) U.S. Cl. 310/311

(57) ABSTRACT

A composite material (5) including a first and a second component (11, 12), which are integrally joined, is described. The first component (11) behaves like a piezoelectric material and the second component (12) behaves like a magnetoelastic material. The composite material is in particular well-suited for use in a sensing element or in an actuating element, for example, a rotational speed sensor, current sensor, torque sensor, force sensor or a passive sensing element. Also described are methods of manufacturing the composite material. A first method is based on a powder mixture, which is made up of a first powder having the first component (11) and of a second powder having the second component (12), which is compacted and sintered. A second method involves the application of a coating having one of the two components (11, 12) onto nanoscale powder particles having the other particular component (11, 12). A third method involves the production of a layer (13, 14) having one of the two components (11) by sputter deposition or vapor deposition onto a substrate, and a layer (13, 14) having the other particular component is subsequently applied to this layer (13, 14).

The present invention relates to a composite material having piezoresistive and magnetoelastic properties, methods of its manufacture and its use in a sensing element or an actuating element according to the definition of the species of the independent claims.

### BACKGROUND INFORMATION

Piezoelectric materials or materials that display a piezoelectric or reverse piezoelectric effect are widely known. They include, for example, lead-zirconate-titanate ceramics (PZT ceramics) or also ferroelectric piezoceramic materials, such as those offered, for example, by Marco GmbH, Dachau, Germany. In addition, particular reference is made to its Internet pages at www.marco.de and in particular the pages www.marco.de/D/fpm/001/010.html.

Moreover, numerous magnetoelastic materials are known from the related art. Particular reference is made to the materials manufactured and marketed by Etrema Products Inc., Iowa, USA, a summary of which may found in the Internet at www.etrema-usa.com. In particular, Etrema Products Inc. markets a magnetoelastic powder under the trade name Terfenol-D, which is based on a terbium-dysprosium-iron alloy. In addition, a plurality of magnetoelastic materials are known that are based on ferromagnetic powders such as nickel-iron powder or cobalt-iron powder.

Furthermore, in the article “An Innovative Passive Solid-State Magnetic Sensor,” Sensors, October 2000, Y. Li and R. O'Handley described a sensing element that uses both the magnetostrictive effect and the piezoelectric effect. To this end, this sensing element has a piece of a piezoelectric material and a piece of a magnetostrictive material, the magnetostrictive or magnetoelastic material exerting a mechanical strain on the piezoelectric material when an external magnetic field is applied so that the piezoelectric material generates an electrical output signal that is picked off. The cited article is available on the Internet at www.sensorsmag.com/articles/1000/52/main.shtml.

### ADVANTAGES OF THE INVENTION

Compared to the related art, the composite material according to the present invention and the methods of manufacturing it according to the present invention have the advantage that as a result, a novel material is provided or may be manufactured which combines the properties of a piezoelectric material with the properties of a magnetoelastic material. In particular, this is not merely a matter of stringing together different materials of this type but is instead a new material having a plurality of components contained in it which are integrally joined.

Compared to the related art in particular, the composite material according to the present invention makes it possible to manufacture more economical and simpler sensing or actuating elements and also to open up new applications for such sensing or actuating elements. The composite material according to the present invention is suited in particular for use in rotational speed sensors, current sensors, torque sensors, or force sensors to be used, for example, in motor vehicles, power tools or in domestic appliances. In addition, passive sensing elements, i.e., sensing elements requiring no power supply at all, may be implemented with this material in a very advantageous manner.

Another advantage of the composite material according to the present invention is that if used in appropriate sensing elements, it makes contactless measurement of magnetic fields possible without a supply of energy to the sensing element, i.e., passively. Among other things, this also allows a telemetric query of the particular sensor signal without a power supply. In addition, the composite material according to the present invention may also be used under severe conditions or in stressful environments such as, for example, in very high temperatures in the environment of an engine of a motor vehicle or on a brake of a motor vehicle.

Furthermore, the composite material of the present invention offers the advantage that it may also be used to measure electrical fields as a function of a change of the permeability of the composite material. Thus, for example, an electrical voltage applied to the composite material is able to change the resonance frequency of an oscillating circuit. In particular, it is possible in this manner to measure both a static force acting on the composite material according to the present invention using a magnetoelastic pickup known per se as well as a dynamic force acting on the composite material using an appropriate voltage tap at a piezoelectric converter.

The advantages of known magnetoelastic sensors and piezoelectric sensors may thus be combined in any manner desired, it being possible to measure dynamic and static forces using one sensing element having the composite material according to the present invention, it being possible in particular to measure them simultaneously.

In this connection, it is further advantageous that the composite material according to the present invention may be formed using customary forming methods, for example, for use in a force sensor, and that the transmission of force into the composite material is unproblematic since the magnetoelastic or piezoelectric effect in the composite material of the present invention is a volume effect in each case.

Finally, it is advantageous that a sensing element or actuating element including the composite material according to the present invention may also be readily used for self-diagnosis since it is possible to switch from a sensor functionality to an actuator functionality and back again without difficulty.

With respect to the method according to the present invention of manufacturing the composite material, it is advantageous that to a considerable extent, known production methods of manufacturing magnetically soft composite materials or even methods of manufacturing nanoscale powders having a surface coating may be used. It is also advantageous that customary vapor deposition methods or sputter deposition methods such as, for example, chemical vapor deposition (CVD), physical vapor deposition (PVD), physically enhanced chemical vapor deposition (PECVD) or metal organic chemical vapor deposition (MOCVD) may be used to manufacture the composite material according to the present invention.

Advantageous refinements of the present invention are derived from the measures cited in the subclaims.

It is thus advantageous in particular if the first component of the composite material, which behaves like a piezoelectric material, is a ceramic piezoelectric material such as a PZT ceramic. In addition, quartz, zinc oxide, a ferroelectric material such as barium titanate or lead titanate or a ferroelectric piezoceramic material may be considered. The second component of the composite material according to the present invention is advantageously a magnetically soft, strongly magnetoelastic material such as, for example, a nickel-iron alloy, a cobalt-iron alloy, an iron oxide such as Fe₂O₃, a terbium-dysprosium-iron alloy or a nickel-manganese-gallium alloy.

With respect to the structure of the composite material according to the present invention, it has proven to be advantageous if it is manufactured from a mixture of powders from the first component and from the second component, the powder particles used preferably having a mean particle size of 20 nm to 20 mm, 500 nm to 5 mm in particular. Such a powder mix may then be sintered into a molded article in the customary manner.

It is further advantageous if the composite material according to the present invention is built up of at least two, preferably, however, a plurality of layers, which are stacked on one another, and have the first component of the piezoelectric material and the second component of the magnetoelastic material in alternation. Each of these layers then has a thickness of less than 2 mm, less than 500 nm in particular.

Finally, it has proven to be advantageous if the first or second component is present as a nanoscale powder, which is superficially provided with a coating of the other component. In this connection, it is of particular advantage if the powder particles are made up of the second component, i.e., the magnetoelastic material, and if the surface coating is formed from the piezoelectric material, i.e., the first component.

### DRAWING

The present invention will be described in greater detail with reference to the drawing and in the following description. FIG. 1 shows a schematic diagram of a first exemplary embodiment of a composite material, which is connected to a voltage source via electrodes;

FIG. 2 shows a second exemplary embodiment and FIG. 3 shows a third exemplary embodiment.

### DESCRIPTION OF THE EXEMPLARY EMBODIMENTS

The composite material explained below and the explained methods of manufacturing it are based on the fundamental knowledge that magnetic fields, static magnetic fields in particular, produce expansions or contractions in a magnetoelastic material due to the magnetoelastic effect, which then induce electrical voltages in the piezoelectric material also contained in the composite material.

The conversion chain is typically of such a nature that a magnetoelastic effect is first produced in the composite material according to the present invention via an external magnetic field, which is produced, for example, by a coil, a magnet or a magnetically soft modulator, the magnetoelastic effect resulting in an expansion or contraction in the area of the composite material, which is taken up by the second component, i.e., the magnetoelastic material.

This expansion or contraction is then transferred in the composite material to the first component, i.e., the piezoelectric material so that a piezoelectric effect occurs there, i.e., an electrical voltage is induced, which may be picked off at the composite material using customary electrodes and may be further processed.

However, it should be pointed out that the reverse conversion path is also possible, i.e., an applied electrical voltage changes the magnetic properties, the permeability, for example, of the composite material and generates a magnetic field through it. Finally, it is also possible to switch back and forth between the two effects as desired.

A first exemplary embodiment, which is explained with reference to FIG. 1, is based on a first powder from a first component 11. First component 11 is a piezoelectric material or behaves like one under an applied electrical voltage or mechanical stress. In addition, a second powder from a second component 12 is provided, second component 12 being a magnetoelastic material or behaves like one under the influence of an applied mechanical stress or a magnetic field.

The first and second powders are preferably used as powders having a mean particle size of 20 nm to 20 mm, 500 nm to 5 mm in particular. In addition, these starting powders are preferably mixed with a binder, an organic binder, for example, and/or a customary compacting agent.

After the two powders from first component 11 and second component 12 have been mixed and the organic binder has been added, a forming operation takes place, for example, a compaction or cold compaction so that a molded article is then obtained. This molded article is then subjected to customary debinding and finally sintered so that a composite material 5 is produced from first component 11 and second component 12, these components being integrally joined.

As shown in FIG. 1, the surface of composite material 5 may then be provided with electrodes 20, which are connected to a voltage source 25. However, a voltage tap may also be provided instead of voltage source 25. Electrodes 20 are produced in a customary manner by vapor deposition, sputter deposition or even gluing or pressing on.

Moreover, it should be pointed out that the depiction according to FIG. 1 is only a schematic drawing, i.e., the powder particles of first or second component 11, 12 do not by any means have to be of equal size or display the orderly arrangement shown.

Furthermore, it should be noted that the proportion of the organic binder in the molding composition produced before compaction is selected to be as low as possible so that composite material 5 ultimately obtained has as high a density as possible after sintering.

Specifically, a ceramic piezoelectric powder such as customary PZT powder or even a quartz powder, a zinc oxide powder, a barium titanate powder, a lead titanate powder or a ferroelectric piezoceramic powder, are suitable, for example, as powders for first component 11.

The second powder, which is provided by second component 12, is preferably a ferromagnetic, magnetically soft powder in particular such as a powder of a nickel-iron alloy, a cobalt-iron alloy, an iron oxide powder such as Fe₂O₃ powder, a powder of a terbium-dysposium-iron alloy or a nickel-manganese-gallium alloy.

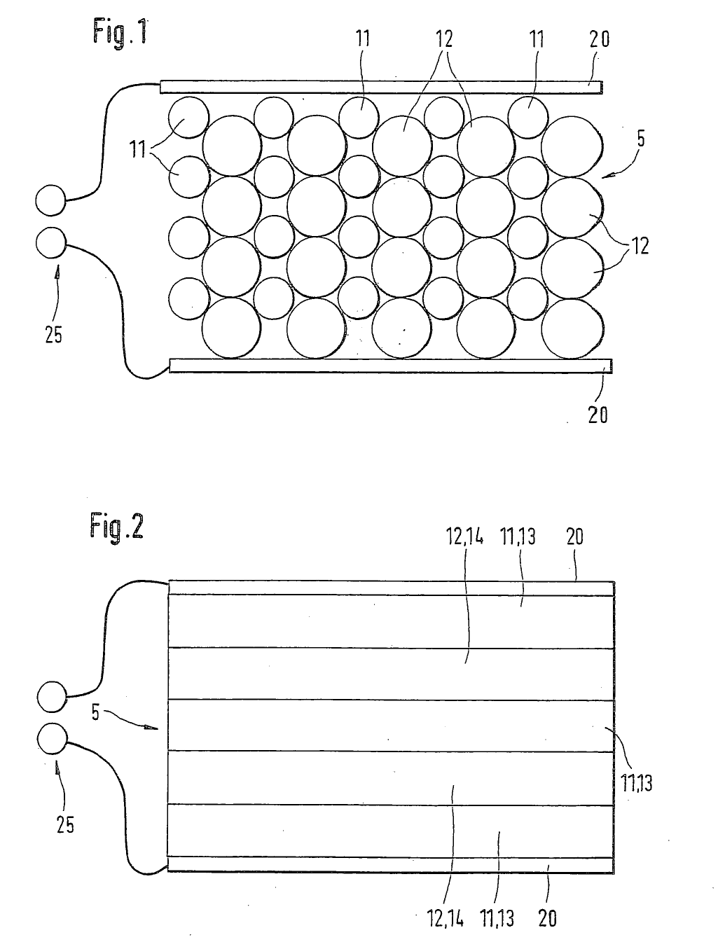

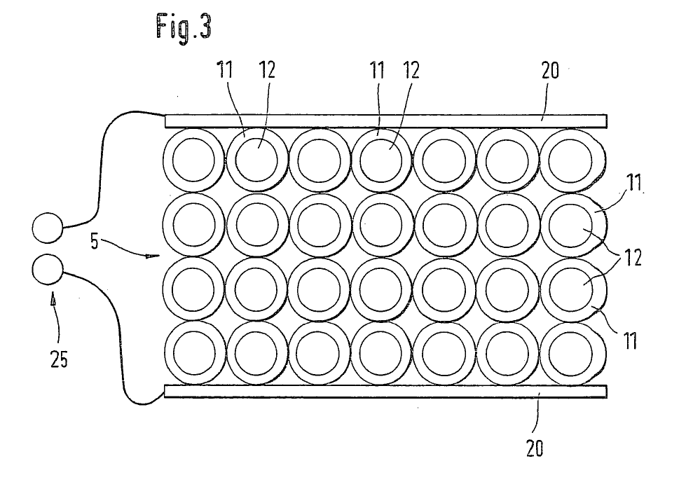

A second exemplary embodiment is explained with reference to FIG. 2. There it is provided that composite material 5 is formed from a plurality of stacked first layers 13 and second layers 14, each first layer 13 being made up from first component 11 and each second layer 14 being made up from second component 12. The thickness of individual layers 13, 14 is normally less than 2 mm, less than 500 nm in particular.

In order to manufacture the layer system according to FIG. 2, first layer 13 from first component 11 is first vapor deposited or sputtered onto largely any kind of substrate; thereafter, second layer 14 from second component 12 is sputtered or vapor deposited onto first layer 13; first layer 13 is subsequently repeated, etc. Obviously, second layer 14 may also be vapor deposited onto the substrate first and then first layer 13 deposited on it, etc. Finally, as explained above, electrodes 20 are attached to the layer system produced.

Conventional physical/chemical deposition methods of manufacturing functional layers such as, for example, the CVD method, the PVD method, the PECVD method or even the MOCVD method are suitable for depositing individual layers 13, 14, the MOCVD method being explained in detail using the example of the manufacture of oxides from metalorganic precursors or precursor compounds in R. Xu, Journal of Materials, October 97, Vol. 49, No. 10, “The Challenge of Precursor Compounds in the MOCVD of Oxides.” This article is available on the Internet at www.tms.org/pubs/journals/JOM/9710/Xu/Xu-9710.html.

The materials for first component 11 already explained based on the first exemplary embodiment are suitable for forming first layer 13 from first component 11. The same also applies to the materials of second layer 14 from second component 12.

A third exemplary embodiment of the present invention is explained with reference to FIG. 3. It is provided in this connection that nanoscale powder particles from second component 12, i.e., the magnetoelastic material, having a mean particle size of 20 nm to 300 μm, are provided with a surface coating from the material of first component 11, i.e., the piezoelectric material. However, it should be emphasized that the procedure may also be reversed, i.e., nanoscale powder particles of first component 11 are provided with a surface coating of the material of second component 12.

A molded article is then produced from the thus obtained surface-coated powder of nanoscale particles. This is accomplished, for example, by compaction, cold compaction in particular, and subsequent sintering.

To this end, by analogy to the first exemplary embodiment, a binder, which is organic in particular, and/or a compacting agent may first be added to the powder including the surface-coated nanoscale particles so that the substance thus obtained may be simply compacted, subsequently subjected to debinding and finally sintered in the customary manner.

Preferably, the nanoscale particles explained above, which have a surface coating, are produced in a plasma by producing the second material, for example, including the nanoscale particles in the plasma from a precursor compound, in particular a metalorganic precursor compound such as, for example, nickel-iron-carbonyl.

Specifically, a suitable metalorganic precursor compound in the plasma is converted into nanoscale powder particles from first component 11, or preferably, second component 12. Simultaneously, the plasma causes the organic constituents to be removed from the precursor compound on the surface of the formed nanoscale particles so that it is possible to provide these surfaces with the desired surface coating in a subsequent processing step, for example, in the plasma, by the specific addition of a suitable reactant. In particular, the addition of the reactant to the plasma is only temporary.

Preferably, the added reactant is an additional precursor compound or a reactive gas so that a surface coating from the material of first component 11, i.e., a piezoelectric material such as, for example, zinc oxide is formed on the surface of the nanoscale particles from second component 12 from this additional precursor compound or reactive gas. Oxygen, for example, is suitable as a reactive gas.

On the whole, a surface coating having a typical thickness of 10 nm to 300 nm, preferably 20 nm to 100 nm, is produced in this way on the nanoscale powder particles.

Moreover, in the case of the explained surface coating of the nanoscale powder particles, it should be noted that the applied coating envelops the individual nanoscale powder particles as completely as possible.

The powder particles corresponding to the first exemplary embodiment having a corresponding particle size are suitable as materials for the nanoscale powder, i.e., second component 12. In addition to zinc oxide, barium titanate is primarily suitable as the material for the surface coating, i.e., for first component 11.

In connection with the above exemplary embodiment, it is in addition highly expedient to apply a magnetic field to the powder particles at the time the surface coating is produced on the nanoscale powder particles in order to thus already obtain a largely uniform alignment of the magnetic domains in the nanoscale powder particles from the magnetoelastic material. This results in a later increased sensitivity of the obtained composite material with respect to a desired sensing direction.

What is claimed is:

1. A composite material comprising a first component and a second component that are integrally joined,
wherein the first component (11) behaves like a piezoelectric material under the influence of an electrical voltage or a mechanical stress applied to the composite material (5); and the second component (12) behaves like a magnetoelastic material under the influence of a mechanical stress or a magnetic field applied to the composite material (5).

2. The composite material as recited in claim 1,
wherein the first component (11) is or includes a ceramic piezoelectric material, in particular PZT ceramic, quartz, zinc oxide, a ferroelectric material such as BaTiO₃ or PbTiO₃ or a ferroelectric piezoceramic material.

3. The composite material as recited in claim 1,
wherein the second component (12) is or includes a ferromagnetic material, a magnetically soft material in particular.

4. The composite material as recited in claim 1 or 3,
wherein the second component (12) is or includes an NiFe alloy, a CoFe alloy, an iron oxide such as Fe₂O₃, a TbDyFe alloy or an NiMnGa alloy.

5. The composite material as recited in one of the preceding claims,
wherein the first component (11) forms a first layer (13) and the second component a second layer (14).

6. The composite material as recited in claim 5,
wherein a plurality of first and second layers (13, 14) is provided, which are stacked on one another in alternation, and each of which has a thickness less than 2 mm, less than 500 nm in particular.

7. The composite material as recited in one of the preceding claims,
wherein the second component (12) has nanoscale powder particles having a mean particle size of 20 nm to 300 nm, at least a portion of the powder particles being provided with a surface coating having the material of the first component (11).

8. The composite material as recited in one of the preceding claims,
wherein the first component (11) has nanoscale powder particles having a mean particle size of 20 nm to 300 nm, at least a portion of the powder particles being provided with a surface coating having the material of the second component (12).

9. The composite material as recited in one of the preceding claims,
wherein it is sintered to form a molded article.

10. A method of manufacturing a composite material as recited in one of the preceding claims comprising the process steps a.) providing a first powder having a first component (11), which behaves like a piezoelectric material under the influence of an applied electrical voltage or a mechanical stress, and a second powder having a second component (12), which behaves like a magnetoelastic material under the influence of an applied mechanical stress or a magnetic field; b.) mixing the powders, c.) compacting the powder mixture; and d.) sintering the compacted powder mixture.

11. The method as recited in claim 10,
wherein a binder, which is organic in particular, and/or a compacting agent is added to the powder mixture before compaction, and the compacted powder mixture is subjected to debinding before sintering.

12. The method as recited in claim 10 or 11,
wherein a powder having a mean particle size of 20 nm to 20 mm, 500 nm to 5 mm in particular, is used as first and/or second powder.

13. A method of manufacturing a composite material as recited in one of claims 1 through 9 comprising the process steps a.) providing or producing a second component (12) having nanoscale particles, which behave like a magnetoelastic material under the influence of an applied mechanical stress or a magnetic field, b.) applying a coating having a first component (11) to the surface of the nanoscale particles, the first component (11) behaving like a piezoelectric material under the influence of an applied electrical voltage or a mechanical stress.

14. The method as recited in claim 13,
wherein the surface-coated nanoscale particles are produced in the form of a powder, which is then subjected to a forming operation.

15. The method as recited in claim 14,
wherein the forming operation takes place by compaction, by cold compaction in particular, and the molded article obtained is subsequently sintered.

16. The method as recited in claim 14 or 15,
wherein a binder, which is organic in particular, and/or a compacting agent is first added to the powder and the substance thus obtained is then compacted, subjected to debinding and sintered.

17. The method as recited in one of claims 13 through 16,
wherein the second component (12) including nanoscale particles is produced in a plasma from a precursor compound, a metalorganic precursor compound in particular.

18. The method as recited in one of claims 13 through 17,
wherein the coating including the first component (11) is applied to the surface of the nanoscale particles in a plasma by the, in particular, temporary addition of an additional precursor compound or a reactive gas to the plasma.

19. The method as recited in one of claims 13 through 18,
wherein the surface coating is produced having a thickness of 10 nm to 300 nm, 20 nm to 100 nm in particular.

20. A method of manufacturing a composite material as recited in one of claims 1 through 9 comprising the process steps a.) providing or producing a first component (11) having nanoscale particles, which behave like a piezoelectric material under the influence of an applied electrical voltage or a mechanical stress; and b.) applying a coating having a second component (12) to the surface of the nanoscale particles, the second component (12) behaving like a magnetoelastic material under the influence of an applied mechanical stress or a magnetic field.

21. A method of manufacturing a composite material as recited in one of claims 1 through 9 comprising the process steps a.) providing a first layer (13) having a first component (11) by sputter deposition or vapor deposition onto a substrate, the first component (11) behaving like a piezoelectric material under the influence of an applied electrical voltage or a mechanical stress; and b.) producing a second layer (14) having the second component (12) by sputter deposition or vapor deposition onto the first layer (13), the second component (12) behaving like a magnetoelastic material under the influence of an applied mechanical stress or a magnetic field.

22. A method of manufacturing a composite material as recited in one of claims 1 through 9 comprising the process steps a.) producing a second layer (14) having a second component (12) by sputter deposition or vapor deposition onto a substrate, the second component (12) behaving like a magnetoelastic material under the influence of an applied mechanical stress or a magnetic field; and b.) producing a first layer (13) having a first component (11) by sputter deposition or vapor deposition onto the second layer (14), the first component (11) behaving like a piezoelectric material under the influence of an applied electrical voltage or a mechanical stress.

23. The method as recited in claim 21 or 22,
wherein at least two, in particular a plurality of, stacked layers (13, 14) are produced, the layers (13, 14) having the first component (11) and the second component (12) in alternation.

24. The method as recited in claim 21 or 22,
wherein the vapor deposition or sputter deposition is carried out using a CVD method, a PVD method, an MOCVD method or a PECVD method.

25. Use of a composite material as recited in one of the preceding claims in a sensing element or an actuating element, in particular a rotational speed sensor, a current sensor, a torque sensor, a force sensor or a passive sensing element.
